(19) United States
(12) Patent Application Publication
(10) Pub. No.: US 2024/0303118 A1
(43) Pub. Date: Sep. 12, 2024

(54) Managing Vehicle Computing Resources

(71) Applicant: QUALCOMM Incorporated, San Diego, CA (US)

(72) Inventors: Kapil GULATI, Belle Mead, NJ (US); Agrim BARI, Austin, TX (US); Hong CHENG, Basking Ridge, NJ (US); Shailesh PATIL, San Diego, CA (US); Gene Wesley MARSH, San Diego, CA (US)

(21) Appl. No.: 18/180,592

(22) Filed: Mar. 8, 2023

(51) Int. Cl. G06F 9/50

(52) U.S. Cl. CPC G06F 9/5027

(57) ABSTRACT

Various embodiments include methods and systems for identifying vehicle computing resources with capacity that can be offered to support remote computing systems with Edge computing services. Various embodiments may include identifying an operating state of a vehicle computing system not responsible for vehicle navigation or maneuvering, selecting an available computing capacity of the computing system based on the identified operating state, and offering the available computing capacity of the computing system to perform a computing task received from a network computing device. In some embodiments, selecting an available computing capacity of the computing system may include identifying a predetermined available computing capacity of the computing system corresponding to the identified operating state in a data table stored in memory. In some embodiments, identifying the operating state of the computing system may include receiving information regarding which of a limited number of system functions that the computing system is performing.

### BACKGROUND

Edge computing is a distributed computing paradigm that provides network computing devices with supporting computational capabilities and data storage positioned closer in the network to user equipment such as mobile devices. Edge computing devices can supplement computing capabilities of other computing devices that are physically close.

The computing capabilities of autonomous and semi-autonomous vehicles is increasingly rapidly, and vehicle computing system can also function as Edge computers to offer surplus computing capacity to other computing devices, such as smartphones within the vehicle, or even to external computers connected via wireless communications. A computing device such as a network server that provides Edge computing services can assess current processing loads, executing threads, memory utilization and capacity before advertising a level of surplus computing capacity to other computing devices. However, the availability of computing capacity of a vehicle computing system will necessarily depend on the operating conditions of the vehicle, which are dynamic and highly variable, making conventional capacity determinations difficult if not unreliable.

### SUMMARY

Various aspects include methods that may be performed by a vehicle processing system for managing vehicle computing resources. In some aspects, a vehicle processing system may perform methods that include identifying an operating state of a first computing system within a vehicle different from a vehicle computing system that is responsible for vehicle navigation and/or maneuvering, selecting an available computing capacity of the first computing system based on the identified operating state of the first computing system, and offering the available computing capacity of the first computing system to perform a computing task received from a network computing device.

In some aspects, offering the available computing capacity of the first computing system to perform the computing task received from the network computing device may include transmitting a message to the network computing device offering the available computing capacity of the first computing system to the network computing device. In such aspects, the method may further include receiving the computing task from the network computing device in response to the message offering the available computing capacity of the first computing system.

In some aspects, selecting the available computing capacity of the first computing system based on the identified operating state of the first computing system may include identifying a predetermined available computing capacity of the first computing system corresponding to the identified operating state in a data table stored in memory. In some aspects, identifying the operating state of the first computing system may include receiving information regarding which of a limited number of system functions that the first computing system is performing.

In some aspects, the first computing system may be a vehicle infotainment system, identifying the operating state of the first computing system may include identifying one or more of a quantity of active media sessions, a quantity of active displays, or content being rendered by the vehicle infotainment system, and selecting the available computing capacity of the first computing system based on the identified operating state of the first computing system may include identifying the available computing capacity of the vehicle infotainment system based on one or more of the quantity of active media sessions, the quantity of active displays, and the content being rendered by the vehicle infotainment system.

In some aspects, the first computing system may be a vehicle communication system, identifying the operating state of the first computing system may include identifying whether an external communication link of a particular type is active or inactive in the vehicle communication system, and selecting the available computing capacity of the first computing system based on the identified operating state of the first computing system may include identifying the available computing capacity of the vehicle communication system based on whether the external communication link of the particular type is active or inactive.

In some aspects, the first computing system may be a vehicle extended reality (XR) system, identifying the operating state of the first computing system may include identifying whether the vehicle XR system is in use, and selecting the available computing capacity of the first computing system based on the identified operating state of the first computing system may include identifying the available computing capacity of the vehicle XR system based on whether the vehicle XR system is in use.

In some aspects, the first computing system may be a vehicle Edge computing system, identifying the operating state of the first computing system may include identifying whether any Edge computing operations are being performed by the Edge computing system, and selecting the available computing capacity of the first computing system based on the identified operating state of the first computing system may include identifying the available computing capacity of the vehicle Edge computing system based on whether any Edge computing operations are being performed by the Edge computing system.

Further aspects include a vehicle processing system including a memory and a processor configured to perform operations of any of the methods summarized above. Further aspects may include a vehicle processing system having various means for performing functions corresponding to any of the methods summarized above. Further aspects may include a non-transitory processor-readable storage medium having stored thereon processor-executable instructions configured to cause a processor of a vehicle processing system to perform various operations corresponding to any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example communication system suitable for implementing various embodiments.

FIG. 1B is a system block diagram illustrating an example disaggregated base station architecture suitable for implementing various embodiments.

FIG. 2 is a component diagram of an example vehicle V2X processing system suitable for implementing various embodiments.

FIG. 3 is a block diagram illustrating components of a system on chip for use in a vehicle V2X processing system in accordance with various embodiments.

FIG. 4 is a system block diagram illustrating an example Edge computing system suitable for use with various embodiments.

FIG. 5A is a process flow diagram of an example method performed by a processor of computing system for managing vehicle computing resources in accordance with various embodiments.

FIGS. 5B-5F are process flow diagrams of example operations that may be performed by a processor of computing system as part of the method for managing vehicle computing resources in accordance with some embodiments.

FIG. 6 is a component block diagram of a network computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and vehicle processing systems implementing the methods, for identifying vehicle computing resources that may be offered to an Edge computing network for providing Edge computing services. In various embodiments, a vehicle processing system, other than a system that performs vehicle navigation and/or maneuvering operations, may determine an available surplus computing capacity that can be used for Edge computing services based on vehicle operating conditions, and then advertise available surplus computing capacity for supporting Edge computing services, such as by offering the capacity to an Edge network computing device. The vehicle processing system may perform a received computing task for (or on behalf of) another computing device when providing Edge computing services. The other computing device can be, for example, another vehicle processing system, a mobile device (e.g., a smartphone or other similar computing device), or a network computing device such as an Edge server.

As used herein, the term “vehicle” refers generally to any of an automobile, motorcycle, truck, bus, train, boat, and any other type of vehicle V2X-capable system that may be configured to manage transmission of misbehavior reports.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The computing capabilities of autonomous and semi-autonomous vehicles can also function to offer and provide surplus computing capacity to other computing devices, such as smartphones within the vehicle, or to external computers connected via wireless communications (essentially becoming a participant in an Edge computing network or in “cloud” computing). Typically, a computing device (e.g., a network server) providing Edge computing services assesses current processing loads, executing threads, memory utilization and capacity and, in the case of battery powered system, current battery state before advertising a level of surplus computing capacity to other computing devices.

Various embodiments include methods and vehicle processing systems implementing the methods of managing vehicle computing resources. In various embodiments, a vehicle processing system may identify an operating state of a first computing system within a vehicle different from a vehicle computing system that is responsible for vehicle navigation and maneuvering, select an available computing capacity of the first computing system based on the identified operating state of the first computing system, and offer the available computing capacity of the first computing system to perform a computing task received from a network computing device. Examples of vehicle navigation maneuvering include steering, braking, path planning, maneuver planning and execution, and other similar operations for “driving” the vehicle. In some embodiments, the vehicle processing system may transmit a message to the network computing device offering the available computing capacity of the first computing system to the network computing device, and the vehicle processing system may receive the computing task from the network computing device in response to the message offering the available computing capacity of the first computing system. The vehicle processing system may perform the received computing task, and may transmit to the network computing device an output or work product of the performed computing task.

Conventional determinations of the availability of computing capacity of a computing system involve a relatively slow and processor-intensive assessment of currently-performed operations such as current processing loads, threads executing, memory utilization and capacity, and the like. Such conventional approaches to determining the computing capacity of a vehicle processing system may be inaccurate and unreliable at least in part because the operating conditions of a vehicle are dynamic and highly variable. On the other hand, vehicle computing loads may be somewhat predictable based on an operating state or operating conditions of the vehicle that are well known to, or readily available to, the vehicle processing system.

In some embodiments, the vehicle processing system may identify a predetermined available computing capacity of the first computing system corresponding to the identified operating state in a data table stored in memory (e.g., a memory of the vehicle processing system). In some embodiments, the data table may include a database, a lookup table, a listing of associations of available computing capacity quantities and one or more operating states, or another suitable data table or data representation. It some embodiments, the use of the data table may enable the vehicle processing system to avoid performing time-consuming calculations to determine an available computing capacity of the first computing system.

In some embodiments, the vehicle processing system may receive information regarding which of a limited number of system functions that the first computing system is performing. For example, the first computing system may be a vehicle infotainment system. The vehicle processing system may identify one or more of a quantity of active media sessions, a quantity of active displays, or content being rendered by the vehicle infotainment system. The vehicle infotainment system may identify the available computing capacity of the vehicle infotainment system based on one or more of the quantity of active media sessions, the quantity of active displays, and the content being rendered by the vehicle infotainment system.

As another example, the first computing system may be a vehicle communication system. The vehicle processing system may identify whether an external communication link of a particular type is active or inactive in the vehicle communication system. The vehicle processing system may identify the available computing capacity of the vehicle communication system based on whether the external communication link of the particular type is active or inactive. As another example, the first computing system may be an extended reality (XR) system. In various embodiments, XR may include any of virtual reality (VR), augmented reality (AR), mixed reality (XR), or any other similar system or functionality. The XR system may, for example, be configured to provide advanced information displays such as a heads-up display on a window or windshield of the vehicle, a rendering of environmental information, traffic information, or other information otherwise not visible to a human, such as traffic conditions far ahead of the vehicle, incipient weather conditions, incipient traffic conditions, information about a condition in a driver's blind spot, and other suitable information. The vehicle processing system may identify whether the vehicle XR system is in use. The vehicle processing system may identify the available computing capacity of the vehicle XR system based on whether the vehicle XR system is in use. As another example, the first computing system may be a vehicle Edge computing system. The vehicle processing system may identify whether any Edge computing operations are being performed by the Edge computing system (for example, a system, module, or component configured to perform computing tasks received from an external computing device such as a network computing device). The vehicle processing system may identify the available computing capacity of the vehicle Edge computing system based on whether any Edge computing operations are being performed by the Edge computing system.

Various embodiments improve the efficiency of vehicle processing systems and Edge computing networks by enabling vehicle processing systems to rapidly determine available computing capacity of the computing system, different from a vehicle computing system that is responsible for navigation and maneuvering, and offer the available computing capacity to another computing system or device, such as an Edge network device or even to another vehicle. Various embodiments improve the speed by which vehicle processing systems may determine available computing capacity of the computing system based on an operating state or operating conditions of the vehicle that are well known to, or readily available to, the vehicle processing system, and in this manner avoiding the performance of complex and time-consuming calculations to determine such available computing capacity.

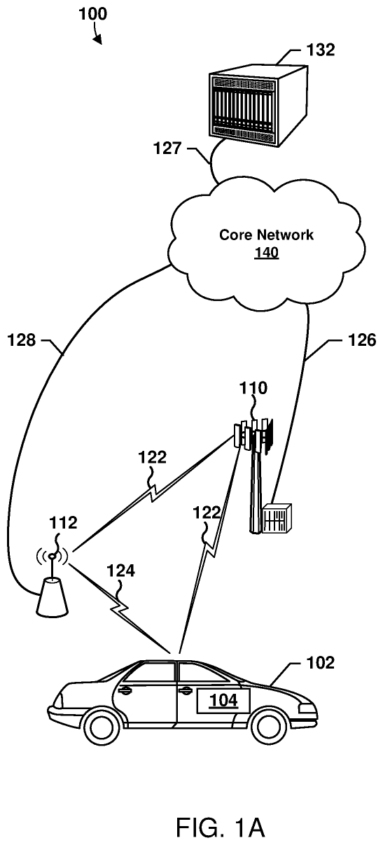

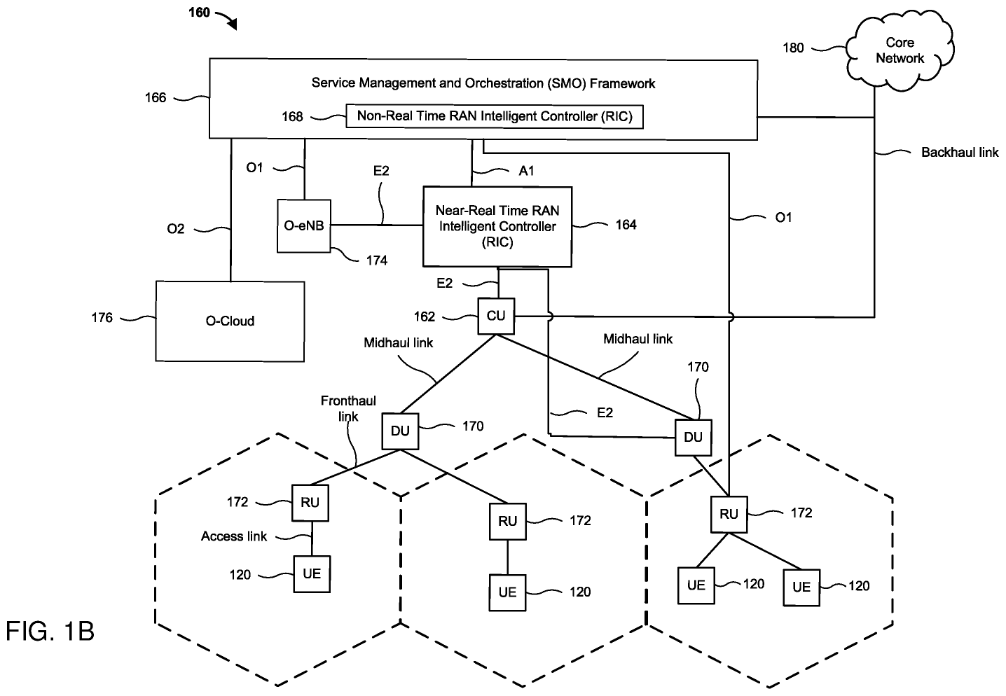

FIG. 1A is a system block diagram illustrating an example communication system 100 suitable for implementing the various embodiments. The communications system 100 include a 5G New Radio (NR) network, an intelligent transportation system (ITS) V2X wireless network, and/or any other suitable network such as a Long Term Evolution (LTE) network. References to a 5G network and 5G network elements in the following descriptions are for illustrative purposes and are not intended to be limiting.

The communications system 100 may include a heterogeneous network architecture that includes a core network 140, a number of base stations 110, and a variety of mobile devices including a vehicle 102 equipped with a V2X processing system 104 that includes wireless communication capabilities. The base station 110 may communicate with a core network 140 over a wired communication link 126. The communications system 100 also may include roadside units 112 supporting V2X communications with vehicles 102 via V2X wireless communication links 124.

A base station 110 is a network element that communicates with wireless devices (e.g., a V2X processing system 104 of the vehicle 102) via a wireless communication link 122, and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station 110 may provide communication coverage for a particular geographic area or “cell.” In 3GPP, the term “cell” can refers to a coverage area of a base station, a base station subsystem serving this coverage area, or a combination thereof, depending on the context in which the term is used. The core network 140 may be any type of core network, such as an LTE core network (e.g., an evolved packet core (EPC) network), 5G core network, a disaggregated network as described with reference to FIG. 1B, etc.

Roadside units 112 may communicate with the core network 140 via a wired or wireless communication link 128. Roadside units 112 may communicate via V2X wireless communication links 124 with V2X processing system-equipped vehicles 102 for downloading information useful for V2X processing system autonomous and semi-autonomous driving functions, and for receiving information such as misbehavior reports from the V2X processing system 104.

A Misbehavior Authority network computing device (MA) 132 may communicate with the core network 140 via a wired or wireless communication link 127. The MA 132 may receive misbehavior reports from the V2X processing system 104 as may be sent by the V2X processing system 104 from time to time.

Wireless communication links 122 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

FIG. 1B is a system block diagram illustrating an example disaggregated base station 160 architecture that may be part of a V2X and/or 5G network (e.g., the communication system 100) according to any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a V2X processing system 104, may be simultaneously served by multiple RUs 172. Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

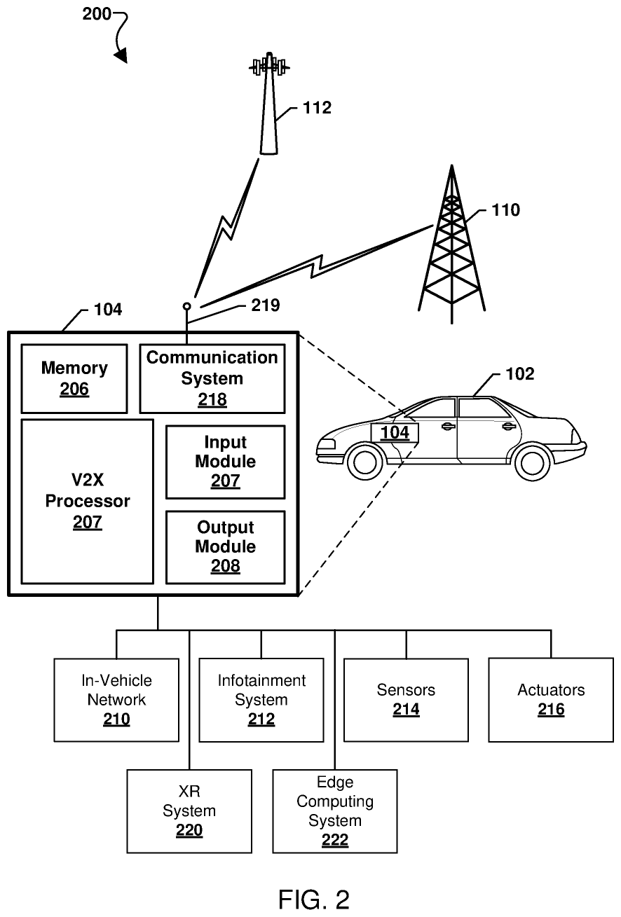

FIG. 2 is a component diagram of example vehicle processing systems 200 suitable for implementing various embodiments. With reference to FIGS. 1A-2, within vehicle processing systems 200 a vehicle 102 may include, for example, a V2X processing system 104, an infotainment system 212, various sensors 214, various actuators 216, a communication system 218 coupled to an antenna 219 (which may be components of the vehicle communication system), an XR system 220, and an Edge computing system 222. Such processing systems may be configured to communicate data, commands and status information with one another, such as via an in-vehicle network 210 within the vehicle 102. The vehicle V2X processing system 104 also may communicate with roadside units 112, cellular communication network base stations 110, and other external devices, such as Edge network computing devices and other vehicles, via the vehicle communication system 218.

The V2X processing system 104 may include a processor 205, memory 206, an input module 207, an output module 208 and the communication system 218. The processor 205 may be coupled to the memory 206 (i.e., a non-transitory storage medium), and may be configured with processor-executable instructions stored in the memory 206 to perform operations of the methods according to various embodiments described herein. Also, the processor 205 may be coupled to the output module 208, which may control in-vehicle displays, and to the input module 207 to receive information from vehicle sensors as well as driver inputs.

The V2X antenna 219 and communication system 218 may be configured to receive dynamic traffic flow feature information via an external communication link that facilitates vehicle-to-everything (V2X) communications. The V2X processing system 104 may include a V2X antenna 219 coupled to the communication system 218 that is configured to communicate with one or more ITS participants (e.g., stations), a roadside unit 112, and a base station 110 or another suitable network access point. In addition to V2X communications, the communication system 218 may also, or alternatively, be configured to establish wireless communication links with other wireless communication networks and protocols, including 5G networks.

In various embodiments, the V2X processing system 104 may receive, such as via the in-vehicle network 210, information from a plurality of information sources, such as the infotainment system 212, various sensors 214, the various actuators 216, the communication system 218, the XR system 220, and the Edge computing system 222. The V2X processing system may be configured to perform autonomous or semi-autonomous driving functions using map data in addition to sensor data, as further described below.

Examples of an in-vehicle network 210 include a Controller Area Network (CAN), a Local Interconnect Network (LIN), a network using the FlexRay protocol, a Media Oriented Systems Transport (MOST) network, and an Automotive Ethernet network.

Examples of vehicle sensors 214 include a location determining system, such as a Global Navigation Satellite System (GNSS) receiver, a camera, radar, lidar, ultrasonic sensors, infrared sensors, and other suitable sensor devices and systems. Examples of vehicle actuators 216 include various physical control systems such as for steering, brakes, engine operation, lights, directional signals, and the like.

In various embodiments, the V2X processing system 104 may be configured to identify an operating state of a computing system within the vehicle that is different from a vehicle computing system that is responsible for vehicle navigation and maneuvering, such as the infotainment system 212, the communication system 218, the XR system 220, and the Edge computing system 222. The V2X processing system may identify an available computing capacity of such device or system based on the identified operating state of that computing system. For example, with regard to the infotainment system 212, the V2X processing system may identify one or more of a quantity of active media sessions, a quantity of active displays, or content being rendered by the vehicle infotainment system. With respect to the vehicle communication system (e.g., 218, 219), the V2X processing system may identify whether an external communication link of a particular type is active or inactive in the vehicle communication system. With respect to the XR system 220, the V2X processing system may identify whether the vehicle XR system is in use. With respect to the Edge computing system 222, the V2X processing system may identify whether any Edge computing operations are being performed by the Edge computing system.

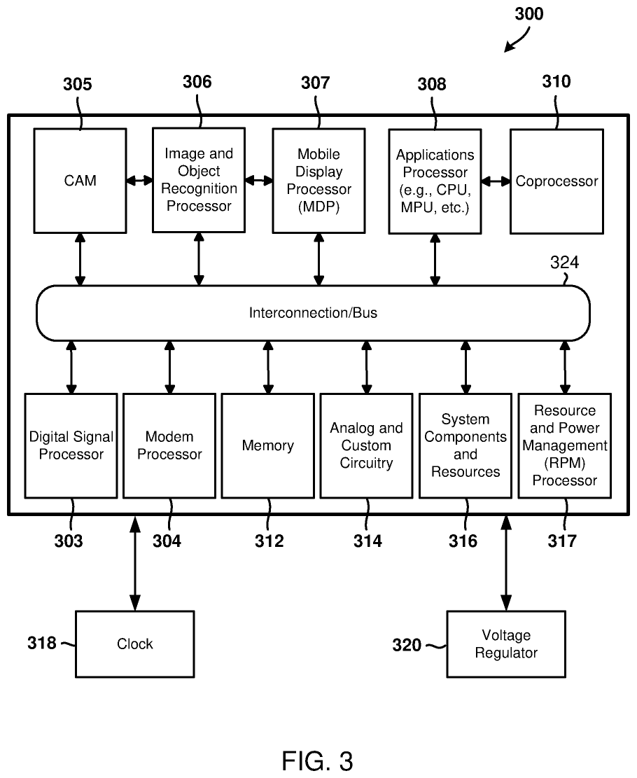

FIG. 3 is a block diagram illustrating an example components of a system on chip (SOC) 300 for use in any of a variety of vehicle processing system in accordance with various embodiments. With reference to FIGS. 1A-3, the processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317.

Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing system.

The processing device SOC 300 also may include specialized circuitry for camera actuation and management (CAM) 305 that includes, provides, controls and/or manages the operations of one or more cameras (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras via the CAM 305 to recognize and/or identify other vehicles, and otherwise perform functions of the camera perception layer 224 as described. In some embodiments, the processor 306 may be configured to process radar or lidar data and perform functions of the radar and/or lidar perception layer 222 as described.

The system components and resources 316, analog and custom circuitry 314, and/or CAM 305 may include circuitry to interface with peripheral devices, such as cameras, radar, lidar, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GNSS receivers, communications circuitry (e.g., Bluetooth®, WLAN, Wi-Fi, etc.), and other well-known components of modern electronic devices.

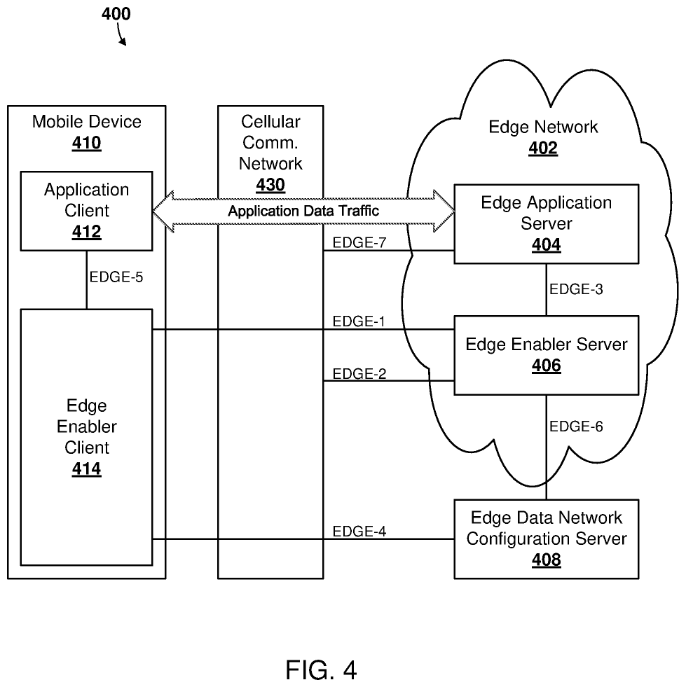

FIG. 4 is a system block diagram illustrating an example Edge computing system 400 suitable for use with various embodiments. In some embodiments, Edge computing system 400 may include an Edge network 402 and a mobile device 410 (which may include or be included in a vehicle processing system, e.g., 104, 106, 108, 200) that may be configured to communicate via a cellular communication network 430. The Edge network 402 may include an Edge application server 402 and an Edge enabler server 406, in communication with an Edge data network configuration server 408. The mobile device 410 may include an application client 412 in communication with an Edge enabler client 412. Each of the elements of the Edge computing system 400 may communicate over an Edge interface (e.g., EDGE-1, EDGE-2, etc.).

The Edge application server 404 and the application client 412 each may be configured to process computing tasks, and may communicate application data traffic (i.e., data related to a computing task) via the cellular communication network 430. The Edge enabler server 406 may be configured to maintain and advertise (e.g., to devices such as the mobile device 410) applications provided by the Edge application server 404. The Edge data network configuration server 408 may be configured to manage communication within and among one or more Edge data networks.

The Edge application server 404 may provide information about its applications and their capabilities to the Edge enabler server 406 via the EDGE-3 interface. The Edge enabler server 406 may provide information about the Edge network 402 to the edge data network configuration server 408 via the EDGE-6 interface. The Edge application server 404 and the Edge enabler server 406 may communicate with the cellular communication network 430 via the EDGE-7 interface and the EDGE-2 interface, respectively.

In some embodiments, the Edge enabler client 414 may obtain information about the available Edge data networks from the Edge data network configuration server 408 via the EDGE-1 interface. In some embodiments, the Edge enabler client 414 may obtain information about Edge application server 404 such as available applications and their capabilities via the EDGE-4 interface. In some embodiments, the Edge enabler client 414, the Edge enabler server 406, and the Edge data network configuration server 408 may employ a discovery and provisioning procedure via their respective Edge interfaces.

The application client 412 may communicate with the Edge enabler client 414 via the EDGE-5 interface. In some embodiments, the Edge enabler client 414 may obtain information about available Edge data networks from the edge data network configuration server 408 via the EDGE-4 interface, and may coordinate the use of the Edge application server 404 with the Edge enabler server 406 via the EDGE-1 interface.

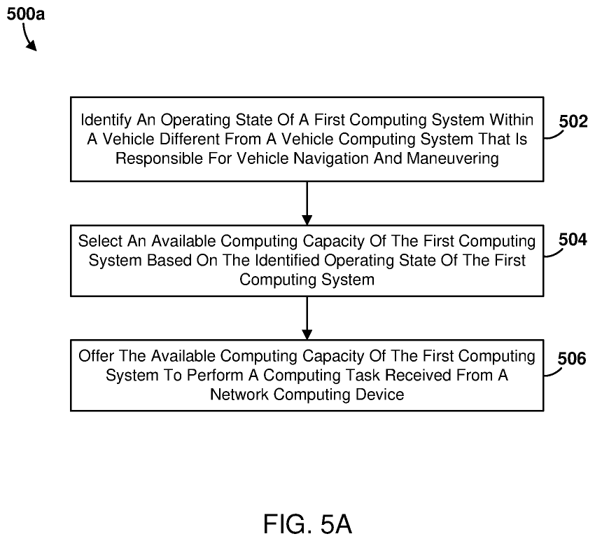

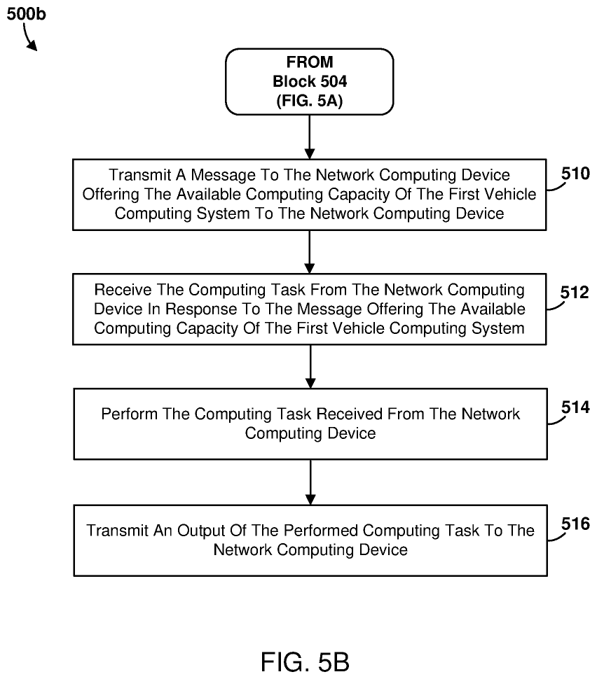

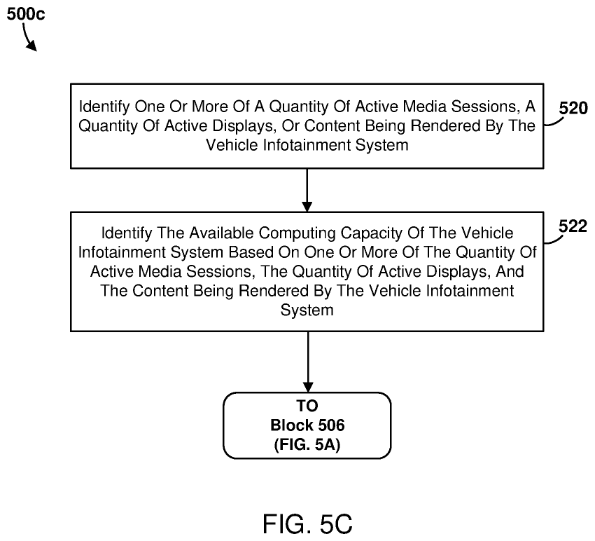

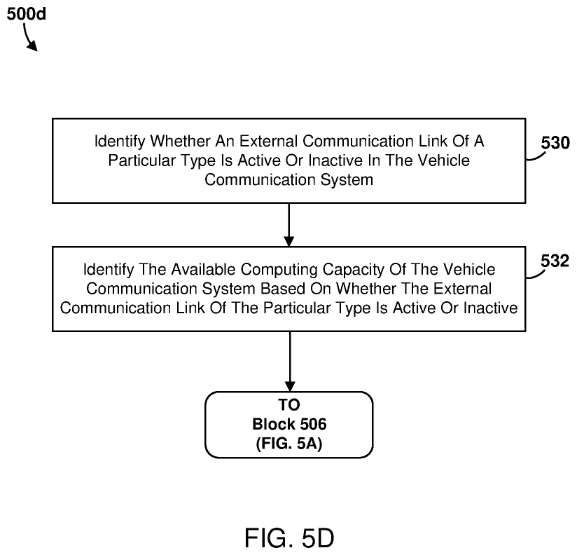

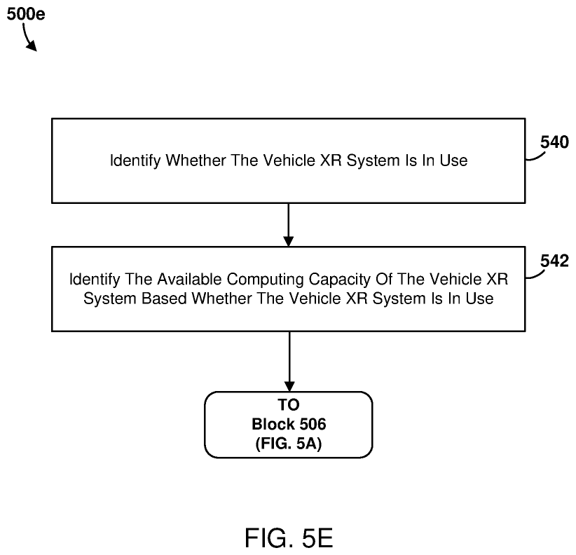

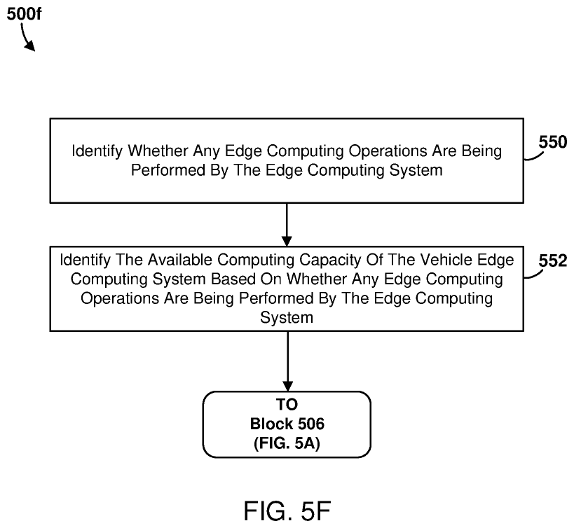

FIG. 5A is a process flow diagram of an example method 500a performed by a processor of computing system, other than a system that performs vehicle navigation and/or maneuvering operations, for managing vehicle computing resources in accordance with various embodiments. With reference to FIGS. 1A-5A, the method 500a may be performed by one or more processors (e.g., 207, 303, 304, 306, 307, 308, 317) of a vehicle computing device that may be implemented in hardware elements, software elements, or a combination of hardware and software elements. Means for performing the operations of the method 500a include a V2X processing system and processors (e.g., 102, 104, 106, 200) of other vehicle processing systems. To encompass any of the processors, hardware elements and software element that may be involved in performing the method 500a, the element or subsystems performing method operations are referred to generally as a “processor.”

In block 502, the processor may identify an operating state of a first computing system within a vehicle different from a vehicle computing system that is responsible for vehicle navigation and maneuvering. For example, the processor may identify an operating state of a vehicle infotainment system, vehicle communication system, vehicle XR system, and/or vehicle Edge computing system, each of which are different from a vehicle computing system that is responsible for vehicle navigation and maneuvering (e.g., steering, braking, path planning, maneuver planning and execution, and other similar operations for “driving” the vehicle). In some embodiments, the processor may receive information regarding which of a limited number of system functions that the first computing system is performing.

In block 504, the processor may select an available computing capacity of the first computing system based on the identified operating state of the first computing system. In some embodiments, selecting the available computing capacity of the first computing system based on the identified operating state of the first computing system may include identifying a predetermined available computing capacity of the first computing system corresponding to the identified operating state in a data table stored in memory.

In block 506, the processor may offer the available computing capacity of the first computing system to perform a computing task received from a network computing device. For example, the processor may transmit a message to a network computing device indicating that the vehicle has available, surplus, or excess computing capacity for the performance of a computing task of another processing system such as the network computing device, another vehicle's computing device, or another suitable computing device.

FIG. 5B is a process flow diagram of example operations 500b that may be performed by a processor of a computing system as part of the method 500a for managing vehicle computing resources in accordance with various embodiments. With reference to FIGS. 1A-5B, the operations 500b may be performed by one or more processors (e.g., 207, 303, 304, 306, 307, 308, 317) of a computing system that may be implemented in hardware elements, software elements, or a combination of hardware and software elements. Means for performing the operations 500b include a V2X processing system and processors (e.g., 102, 104, 106, 200) of other vehicle processing systems. To encompass any of the processors, hardware elements and software element that may be involved in performing the operations 500b, the element or subsystems performing method operations are referred to generally as a “processor.”

After selecting an available computing capacity of the first computing system based on the identified operating state of the computing system (sometimes referred to as a first computing system) in block 504 as described, the processor may transmit a message to the network computing device offering the available computing capacity of the computing system to the network computing device in block 510.

In block 512, the processor may receive the computing task from the network computing device in response to the message offering the available computing capacity of the computing system.

In block 514, the processor may perform the computing task received from the network computing device.

In block 516, the processor may transmit an output of the performed computing task to the network computing device.

FIG. 5C is a process flow diagram of example operations 500c that may be performed by a processor of a computing system as part of the method 500a for managing vehicle computing resources in accordance with various embodiments. With reference to FIGS. 1A-5C, the operations 500c may be performed by one or more processors (e.g., 207, 303, 304, 306, 307, 308, 317) of a computing system that may be implemented in hardware elements, software elements, or a combination of hardware and software elements. Means for performing the operations 500c include a V2X processing system and processors (e.g., 102, 104, 106, 200) of other vehicle processing systems. To encompass any of the processors, hardware elements and software element that may be involved in performing the operations 500c, the element or subsystems performing method operations are referred to generally as a “processor.”

In some embodiments, the first computing system may include a vehicle infotainment system. In such embodiments, the processor may identify that the operating state of the vehicle infotainment system includes one or more of a quantity of active media sessions, a quantity of active displays, or content being rendered by the vehicle infotainment system in block 520.

In block 522, the processor may identify the available computing capacity of the vehicle infotainment system based on one or more of the quantity of active media sessions, the quantity of active displays, and the content being rendered by the vehicle infotainment system.

The processor may offer the available computing capacity of the vehicle infotainment system (the first computing system) to perform a computing task received from a network computing device in block 506, as described.

FIG. 5D is a process flow diagram of example operations 500d that may be performed by a processor of a computing system as part of the method 500a for managing vehicle computing resources in accordance with various embodiments. With reference to FIGS. 1A-5D, the operations 500d may be performed by one or more processors (e.g., 207, 303, 304, 306, 307, 308, 317) of a computing system that may be implemented in hardware elements, software elements, or a combination of hardware and software elements. Means for performing the operations 500d include a V2X processing system and processors (e.g., 102, 104, 106, 200) of other vehicle processing systems. To encompass any of the processors, hardware elements and software element that may be involved in performing the operations 500d, the element or subsystems performing method operations are referred to generally as a “processor.”

In some embodiments, the first computing system may include a vehicle communication system. In such embodiments, the processor may identify whether an external communication link of a particular type is active or inactive in the vehicle communication system in block 530.

In block 532, the processor may identify the available computing capacity of the vehicle communication system based on whether the external communication link of the particular type is active or inactive.

The processor may offer the available computing capacity of the vehicle infotainment system (the first computing system) to perform a computing task received from a network computing device in block 506, as described.

FIG. 5E is a process flow diagram of example operations 500e that may be performed by a processor of a computing system as part of the method 500a for managing vehicle computing resources in accordance with various embodiments. With reference to FIGS. 1A-5E, the operations 500e may be performed by one or more processors (e.g., 207, 303, 304, 306, 307, 308, 317) of a computing system that may be implemented in hardware elements, software elements, or a combination of hardware and software elements. Means for performing the operations 500e include a V2X processing system and processors (e.g., 102, 104, 106, 200) of other vehicle processing systems. To encompass any of the processors, hardware elements and software element that may be involved in performing the operations 500e, the element or subsystems performing method operations are referred to generally as a “processor.”

In some embodiments, the first computing system may include an XR system. In such embodiments, the processor may identify whether the vehicle XR system is in use in block 540.

In block 542, the processor may identify the available computing capacity of the vehicle XR system based whether the vehicle XR system is in use.

The processor may offer the available computing capacity of the vehicle infotainment system (the first computing system) to perform a computing task received from a network computing device in block 506, as described.

FIG. 5F is a process flow diagram of example operations 500e that may be performed by a processor of a computing system as part of the method 500a for managing vehicle computing resources in accordance with various embodiments. With reference to FIGS. 1A-5E, the operations 500e may be performed by one or more processors (e.g., 207, 303, 304, 306, 307, 308, 317) of a computing system that may be implemented in hardware elements, software elements, or a combination of hardware and software elements. Means for performing the operations 500f include a V2X processing system and processors (e.g., 102, 104, 106, 200) of other vehicle processing systems. To encompass any of the processors, hardware elements and software element that may be involved in performing the operations 500e, the element or subsystems performing method operations are referred to generally as a “processor.”

In some embodiments, the first computing system may include a vehicle Edge computing system. In such embodiments, the processor may identify whether any Edge computing operations are being performed by the Edge computing system in block 550.

In block 552, the processor may identify the available computing capacity of the vehicle Edge computing system based on whether any Edge computing operations are being performed by the Edge computing system.

The processor may offer the available computing capacity of the vehicle infotainment system (the first computing system) to perform a computing task received from a network computing device in block 506, as described.

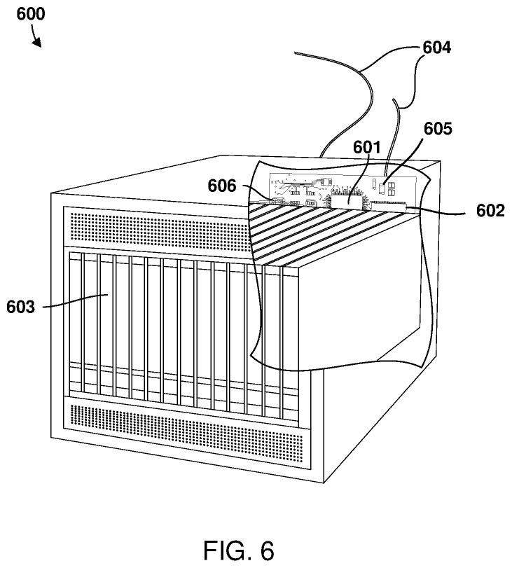

FIG. 6 is a component block diagram of a network computing device 600 suitable for use with various embodiments. With reference to FIGS. 1A-6, various embodiments (including, but not limited to, embodiments described with reference to FIGS. 1A-5F) may be implemented on a variety of computing devices, an example of which is illustrated in FIG. 6 in the form of a server device. A network computing device 600 may include a processor 601 coupled to volatile memory 602 and a large capacity nonvolatile memory, such as a disk drive 603. The network computing device 600 may also include a peripheral memory access device such as a floppy disc drive, compact disc (CD) or digital video disc (DVD) drive 606 coupled to the processor 601. The network computing device 600 may also include network access ports 604 (or interfaces) coupled to the processor 601 for establishing data connections with a network, such as the Internet and/or a local area network coupled to other system computers and servers. The network computing device 600 may include one or more transceivers 605 for sending and receiving electromagnetic radiation that may be connected to a wireless communication link. The network computing device 600 may include additional access ports, such as USB, Firewire, Thunderbolt, and the like for coupling to peripherals, external memory, or other devices.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods and operations 500a-500e may be substituted for or combined with one or more operations of the methods or operations 500a-500e.

Implementation examples are described in the following paragraphs. While some of the following implementation examples are described in terms of example methods, further example implementations may include: the example methods discussed in the following paragraphs implemented by a computing system including a processor configured with processor-executable instructions to perform operations of the methods of the following implementation examples; the example methods discussed in the following paragraphs implemented by a computing system including means for performing functions of the methods of the following implementation examples; and the example methods discussed in the following paragraphs may be implemented as a non-transitory processor-readable storage medium having stored thereon processor-executable instructions configured to cause a processor of a computing system to perform the operations of the methods of the following implementation examples.
Example 1. A method of managing vehicle computing resources, including: identifying an operating state of a first computing system within a vehicle different from a vehicle computing system that is responsible for vehicle navigation or maneuvering; selecting an available computing capacity of the first computing system based on the identified operating state of the first computing system; and offering the available computing capacity of the first computing system to perform a computing task received from a network computing device.
Example 2. The method of example 1, in which offering the available computing capacity of the first computing system to perform the computing task received from the network computing device includes transmitting a message to the network computing device offering the available computing capacity of the first computing system to the network computing device, the method further including receiving the computing task from the network computing device in response to the message offering the available computing capacity of the first computing system.
Example 3. The method of either of examples 1 or 2, in which selecting the available computing capacity of the first computing system based on the identified operating state of the first computing system includes identifying a predetermined available computing capacity of the first computing system corresponding to the identified operating state in a data table stored in memory.
Example 4. The method of any of examples 1-3, in which identifying the operating state of the first computing system includes receiving information regarding which of a limited number of system functions that the first computing system is performing.
Example 5. The method of any of examples 1-4, in which: the first computing system is a vehicle infotainment system; identifying the operating state of the first computing system includes identifying one or more of a quantity of active media sessions, a quantity of active displays, or content being rendered by the vehicle infotainment system; and selecting the available computing capacity of the first computing system based on the identified operating state of the first computing system includes identifying the available computing capacity of the vehicle infotainment system based on one or more of the quantity of active media sessions, the quantity of active displays, and the content being rendered by the vehicle infotainment system.
Example 6. The method of any of examples 1-5, in which: the first computing system is a vehicle communication system; identifying the operating state of the first computing system includes identifying whether an external communication link of a particular type is active or inactive in the vehicle communication system; and selecting the available computing capacity of the first computing system based on the identified operating state of the first computing system includes identifying the available computing capacity of the vehicle communication system based on whether the external communication link of the particular type is active or inactive.
Example 7. The method of any of examples 1-6, in which: the first computing system is a vehicle extended reality (XR) system; identifying the operating state of the first computing system includes identifying whether the vehicle XR system is in use; and selecting the available computing capacity of the first computing system based on the identified operating state of the first computing system includes identifying the available computing capacity of the vehicle XR system based on whether the vehicle XR system is in use.
Example 8. The method of any of examples 1-7, in which: the first computing system is a vehicle Edge computing system; identifying the operating state of the first computing system includes identifying whether any Edge computing operations are being performed by the Edge computing system; and selecting the available computing capacity of the first computing system based on the identified operating state of the first computing system includes identifying the available computing capacity of the vehicle Edge computing system based on whether any Edge computing operations are being performed by the Edge computing system.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,”“then,”“next,” etc. are not intended to limit the order of the operations; these words are simply used to guide the reader through the description of the methods. Further, any reference to claim elements in the singular, for example, using the articles “a,”“an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing vehicle computing resources, comprising:
identifying an operating state of a first computing system within a vehicle different from a vehicle computing system that is responsible for vehicle navigation or maneuvering;
selecting an available computing capacity of the first computing system based on the identified operating state of the first computing system; and
offering the available computing capacity of the first computing system to perform a computing task received from a network computing device.

2. The method of claim 1, wherein offering the available computing capacity of the first computing system to perform the computing task received from the network computing device comprises transmitting a message to the network computing device offering the available computing capacity of the first computing system to the network computing device,
the method further comprising receiving the computing task from the network computing device in response to the message offering the available computing capacity of the first computing system.

3. The method of claim 1, wherein selecting the available computing capacity of the first computing system based on the identified operating state of the first computing system comprises identifying a predetermined available computing capacity of the first computing system corresponding to the identified operating state in a data table stored in memory.

4. The method of claim 1, wherein identifying the operating state of the first computing system comprises receiving information regarding which of a limited number of system functions that the first computing system is performing.

5. The method of claim 1, wherein:
the first computing system is a vehicle infotainment system;
identifying the operating state of the first computing system comprises identifying one or more of a quantity of active media sessions, a quantity of active displays, or content being rendered by the vehicle infotainment system; and
selecting the available computing capacity of the first computing system based on the identified operating state of the first computing system comprises identifying the available computing capacity of the vehicle infotainment system based on one or more of the quantity of active media sessions, the quantity of active displays, and the content being rendered by the vehicle infotainment system.

6. The method of claim 1, wherein:
the first computing system is a vehicle communication system;
identifying the operating state of the first computing system comprises identifying whether an external communication link of a particular type is active or inactive in the vehicle communication system; and
selecting the available computing capacity of the first computing system based on the identified operating state of the first computing system comprises identifying the available computing capacity of the vehicle communication system based on whether the external communication link of the particular type is active or inactive.

7. The method of claim 1, wherein:
the first computing system is a vehicle extended reality (XR) system;
identifying the operating state of the first computing system comprises identifying whether the vehicle XR system is in use; and
selecting the available computing capacity of the first computing system based on the identified operating state of the first computing system comprises identifying the available computing capacity of the vehicle XR system based on whether the vehicle XR system is in use.

8. The method of claim 1, wherein:
the first computing system is a vehicle Edge computing system;
identifying the operating state of the first computing system comprises identifying whether any Edge computing operations are being performed by the Edge computing system; and
selecting the available computing capacity of the first computing system based on the identified operating state of the first computing system comprises identifying the available computing capacity of the vehicle Edge computing system based on whether any Edge computing operations are being performed by the Edge computing system.

9. A computing system for use in a vehicle other than for vehicle navigation or maneuvering, comprising:
a processor configured with processor-executable instructions to:
identify an operating state of the computing system;
select an available computing capacity of the computing system based on the identified operating state of the computing system; and
offer the available computing capacity of the computing system to perform a computing task received from a network computing system.

10. The computing system of claim 9, wherein the processor is further configured to:
offer the available computing capacity of the computing system to perform the computing task received from the network computing system comprises transmitting a message to the network computing system offering the available computing capacity of the computing system to the network computing system; and
wherein the processor is further configured to receive the computing task from the network computing system in response to the message offering the available computing capacity of the computing system.

11. The computing system of claim 9, wherein the processor is further configured to select the available computing capacity of the computing system based on the identified operating state of the computing system by identifying a predetermined available computing capacity of the computing system corresponding to the identified operating state in a data table stored in memory.

12. The computing system of claim 9, wherein the processor is further configured to identify the operating state of the computing system by receiving information regarding which of a limited number of system functions that the computing system is performing.

13. The computing system of claim 9, wherein:
the computing system is a vehicle infotainment system; and
the processor is further configured to:
identify the operating state of the computing system by identifying one or more of a quantity of active media sessions, a quantity of active displays, or content being rendered by the vehicle infotainment system; and
select the available computing capacity of the computing system based on the identified operating state of the computing system by identifying the available computing capacity of the vehicle infotainment system based on one or more of the quantity of active media sessions, the quantity of active displays, and the content being rendered by the vehicle infotainment system.

14. The computing system of claim 9, wherein:
the computing system is a vehicle communication system; and
the processor is further configured to:
identify the operating state of the computing system by identifying whether an external communication link of a particular type is active or inactive in the vehicle communication system; and
select the available computing capacity of the computing system based on the identified operating state of the computing system by identifying the available computing capacity of the vehicle communication system based on whether the external communication link of the particular type is active or inactive.

15. The computing system of claim 9, wherein:
the computing system is a vehicle extended reality (XR) system; and
the processor is further configured to:
identify the operating state of the computing system by identifying whether the vehicle XR system is in use; and
select the available computing capacity of the computing system based on the identified operating state of the computing system by identifying the available computing capacity of the vehicle XR system based on whether the vehicle XR system is in use.

16. The computing system of claim 9, wherein:
the computing system is a vehicle Edge computing system; and
the processor is further configured to:
identify the operating state of the computing system by identifying whether any Edge computing operations are being performed by the Edge computing system; and
select the available computing capacity of the computing system based on the identified operating state of the computing system by identifying the available computing capacity of the vehicle Edge computing system based on whether any Edge computing operations are being performed by the Edge computing system.

17. A computing system for use in a vehicle other than for vehicle navigation or maneuvering, comprising:
means for identifying an operating state of the computing system;
means for selecting an available computing capacity of the computing system based on the identified operating state of the computing system; and
means for offering the available computing capacity of the computing system to perform a computing task received from a network computing system.

18. The computing system of claim 17, wherein means for offering the available computing capacity of the computing system to perform the computing task received from the network computing system comprises means for transmitting a message to the network computing system offering the available computing capacity of the computing system to the network computing system,
the computing system further comprising means for receiving the computing task from the network computing system in response to the message offering the available computing capacity of the computing system.

19. The computing system of claim 17, wherein means for selecting the available computing capacity of the computing system based on the identified operating state of the computing system comprises means for identifying a predetermined available computing capacity of the computing system corresponding to the identified operating state in a data table stored in memory.

20. The computing system of claim 17, wherein means for identifying the operating state of the computing system comprises means for receiving information regarding which of a limited number of system functions that the computing system is performing.

21. The computing system of claim 17, wherein:
the computing system is a vehicle infotainment system;
means for identifying the operating state of the computing system comprises means for identifying one or more of a quantity of active media sessions, a quantity of active displays, or content being rendered by the vehicle infotainment system; and
means for selecting the available computing capacity of the computing system based on the identified operating state of the computing system comprises means for identifying the available computing capacity of the vehicle infotainment system based on one or more of the quantity of active media sessions, the quantity of active displays, and the content being rendered by the vehicle infotainment system.

22. The computing system of claim 17, wherein:
the computing system is a vehicle communication system;
means for identifying the operating state of the computing system comprises means for identifying whether an external communication link of a particular type is active or inactive in the vehicle communication system; and
means for selecting the available computing capacity of the computing system based on the identified operating state of the computing system comprises means for identifying the available computing capacity of the vehicle communication system based on whether the external communication link of the particular type is active or inactive.

23. The computing system of claim 17, wherein:
the computing system is a vehicle extended reality (XR) system;
means for identifying the operating state of the computing system comprises means for identifying whether the vehicle XR system is in use; and
means for selecting the available computing capacity of the computing system based on the identified operating state of the computing system comprises means for identifying the available computing capacity of the vehicle XR system based on whether the vehicle XR system is in use.

24. The computing system of claim 17, wherein:
the computing system is a vehicle Edge computing system;
means for identifying the operating state of the computing system comprises means for identifying whether any Edge computing operations are being performed by the Edge computing system; and
means for selecting the available computing capacity of the computing system based on the identified operating state of the computing system comprises means for identifying the available computing capacity of the vehicle Edge computing system based on whether any Edge computing operations are being performed by the Edge computing system.

25. A non-transitory processor-readable medium having stored thereon processor-executable instructions configured to cause a processor of a computing system of a vehicle that does not support vehicle navigation or maneuvering, comprising:
identifying an operating state of the computing system;
selecting an available computing capacity of the computing system based on the identified operating state of the computing system; and
offering the available computing capacity of the computing system to perform a computing task received from a network computing system.

26. The non-transitory processor-readable medium of claim 25, wherein the stored processor-executable instructions are further configured to cause the processor of the computing system to perform operations such that offering the available computing capacity of the computing system to perform the computing task received from the network computing system comprises transmitting a message to the network computing system offering the available computing capacity of the computing system to the network computing system,
wherein the stored processor-executable instructions are further configured to cause the processor of the computing system to perform operations further comprising receiving the computing task from the network computing system in response to the message offering the available computing capacity of the computing system.

27. The non-transitory processor-readable medium of claim 25, wherein the stored processor-executable instructions are further configured to cause the processor of the computing system to perform operations such that selecting the available computing capacity of the computing system based on the identified operating state of the computing system comprises identifying a predetermined available computing capacity of the computing system corresponding to the identified operating state in a data table stored in memory.

28. The non-transitory processor-readable medium of claim 25, wherein the stored processor-executable instructions are further configured to cause the processor of the computing system to perform operations such that identifying the operating state of the computing system comprises receiving information regarding which of a limited number of system functions that the computing system is performing.

29. The non-transitory processor-readable medium of claim 25, wherein the computing system is a vehicle infotainment system, and wherein the stored processor-executable instructions are further configured to cause the processor of the computing system to perform operations such that:
identifying the operating state of the computing system comprises identifying one or more of a quantity of active media sessions, a quantity of active displays, or content being rendered by the vehicle infotainment system; and
selecting the available computing capacity of the computing system based on the identified operating state of the computing system comprises identifying the available computing capacity of the vehicle infotainment system based on one or more of the quantity of active media sessions, the quantity of active displays, and the content being rendered by the vehicle infotainment system.

30. The non-transitory processor-readable medium of claim 25, wherein the computing system is a vehicle communication system, and wherein the stored processor-executable instructions are further configured to cause the processor of the computing system to perform operations such that:
identifying the operating state of the computing system comprises identifying whether an external communication link of a particular type is active or inactive in the vehicle communication system; and
selecting the available computing capacity of the computing system based on the identified operating state of the computing system comprises identifying the available computing capacity of the vehicle communication system based on whether the external communication link of the particular type is active or inactive.
